(19) United States
(12) Patent Application Publication
(10) Pub. No.: US 2008/0285569 A1
(43) Pub. Date: Nov. 20, 2008

(54) Device for Session-Based Packet Switching

(76) Inventors: Rainer Stademann, Berg (DE); Thomas Theimer, Baierbrunn (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/579,709

(22) PCT Filed: May 6, 2005
(86) PCT No.: PCT/EP2005/52077

§ 371 Date: Nov. 6, 2006

(30) Foreign Application Priority Data
May 7, 2004 (DE) 10 2004 022 552.4

(51) Int. Cl. H04L 12/56

(52) U.S. Cl. 370/395.31

(57) ABSTRACT

Whereas the network architecture for ATM-based access networks on the DSL forum has already been defined, work on Ethernet-based access networks is still in its infancy. The invention relates to a novel aggregation solution for use in Ethernet-based broadband access networks.

### CROSS REFERENCE TO RELATED APPLICATIONS

This application is the US National Stage of International Application No. PCT/EP2005/052077, filed May 6, 2005 and claims the benefit thereof. The International Application claims the benefits of German application No. 102004022552.4 DE filed May 7, 2004, both of the applications are incorporated by reference herein in their entirety.

### FIELD OF INVENTION

The present invention relates to a device for session-based packet switching.

### BACKGROUND OF INVENTION

The architecture for ATM-based broadband access networks with QoS support is described, for example, in DSL Forum Specifications TR-058 and TR-059. These networks are based on permanent ATM virtual connections (PVC) between the user access and a central IP network access node (broadband access server, BAS). The BAS is responsible for access control and user authentication as well as service selection.

This architecture has various disadvantages:
The connections (PVC) between user and BAS must be configured both in the ATM network and in the BAS.
A separate ATM PVC is required for each QoS class
Inter-user traffic must always go via the BAS
Today's BAS products do not permit any low-cost services with high data rates (e.g. several video channels per user)

### SUMMARY OF INVENTION

Future access networks for broadband user access must provide higher bandwidths at lower cost than is possible with today's standard ATM-based access networks. For this reason future networks are to be increasingly based on Ethernet technology which is currently establishing itself in the market as an attractive solution for metro networks.

Whereas the network architecture for ATM-based access network has already been defined in the DSL Forum, work on Ethernet-based access networks is still in its infancy. What is required is a new network architecture for the Ethernet-based aggregation of broadband user accesses which optimally meets the following requirements:
Dynamic network access with authentication and access control
Minimal administration cost/complexity for creating new users
Good scalability
Traffic separation between individual user accesses
Dynamic selection of different services or classes of service
Support of different access methods (e.g. PPPoE, DHCP)
Aggregation of a large number of users into a small number of service-specific logical tunnels
Support of video distribution services
Support for the packet-based voice services (VoIP), particularly Quality of Service
Efficient transport of peer-to-peer applications (Kazaa, etc.)

The subject matter of this invention is a novel aggregation solution for use in Ethernet-based broadband access networks.

### BRIEF DESCRIPTION OF THE DRAWINGS

The invention will now be explained in greater detail with reference to the accompanying drawings comprising nine Figures.

FIG. 1 shows an exemplary network concept schematic of an Ethernet service node;

FIG. 2 show an exemplary block diagram of a simplified Ethernet service node;

FIG. 3 shows an exemplary diagram of session based forwarding

FIG. 4 shows an exemplary VLAN configuration;

FIG. 5 shows an exemplary L2 frame processing;

FIG. 6 shows another exemplary L2 frame processing;

FIG. 7 shows an exemplary generation of a session port;

FIG. 8 shows another exemplary generation of a session port; and

FIG. 9 shows another exemplary generation of a session port.

### DETAILED DESCRIPTION OF INVENTION

The invention defines a new network architecture for Ethernet-based access networks which shifts the BAS function to the aggregation network and modifies it so that access control can take place using Ethernet-based methods. On the one hand this obviates the need for a separate BAS, thereby providing significant cost savings. On the other hand, access control is moved closer to the user, thereby allowing improved QoS support.

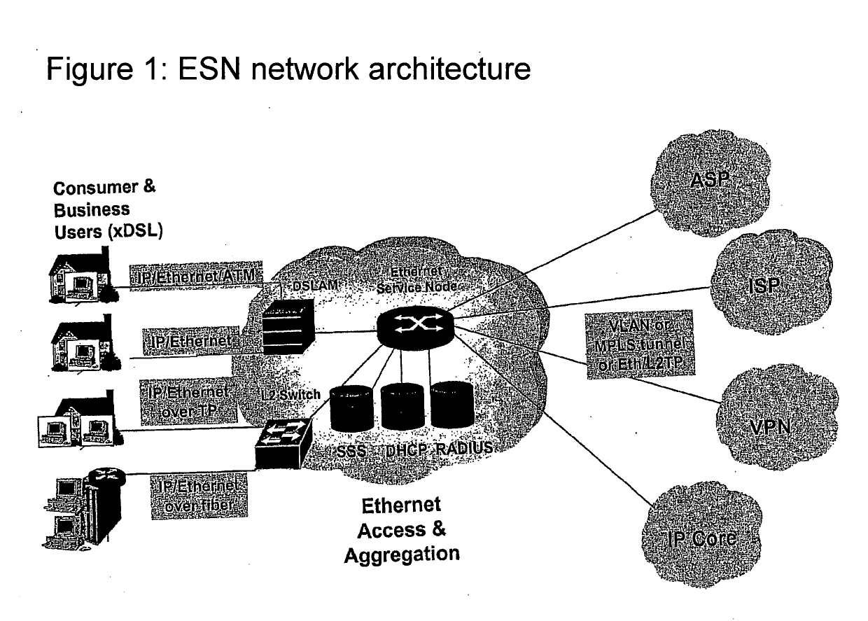

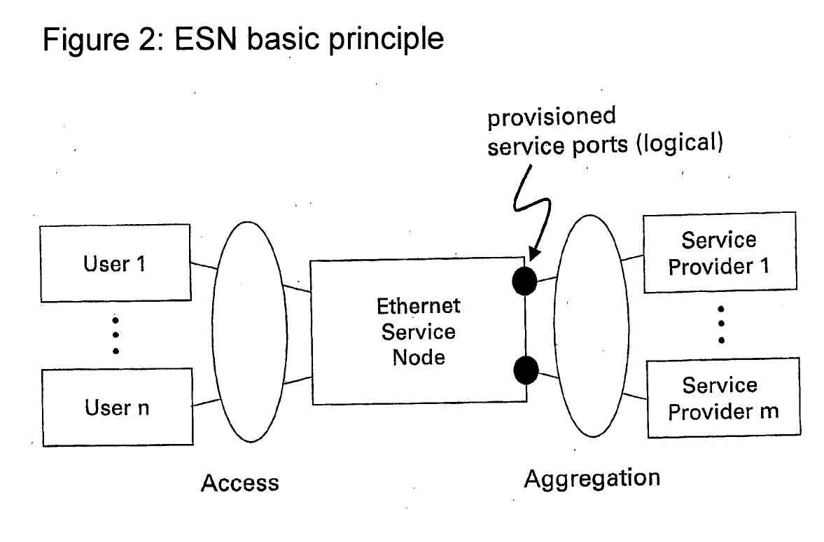

FIG. 1 shows the associated network concept of an Ethernet service node (ESN) to which there are connected, on the user side, a plurality of DSLAMs or Ethernet edge switches (L2 switches). On the network side, the ESN forwards traffic to different service providers, which can be network providers such as ISPs or also application providers for video services or voice services. The ESN aggregates and controls the user traffic and connects the individual user sessions to the corresponding service providers. This is shown in greatly simplified form in FIG. 2 (see Annex 1).

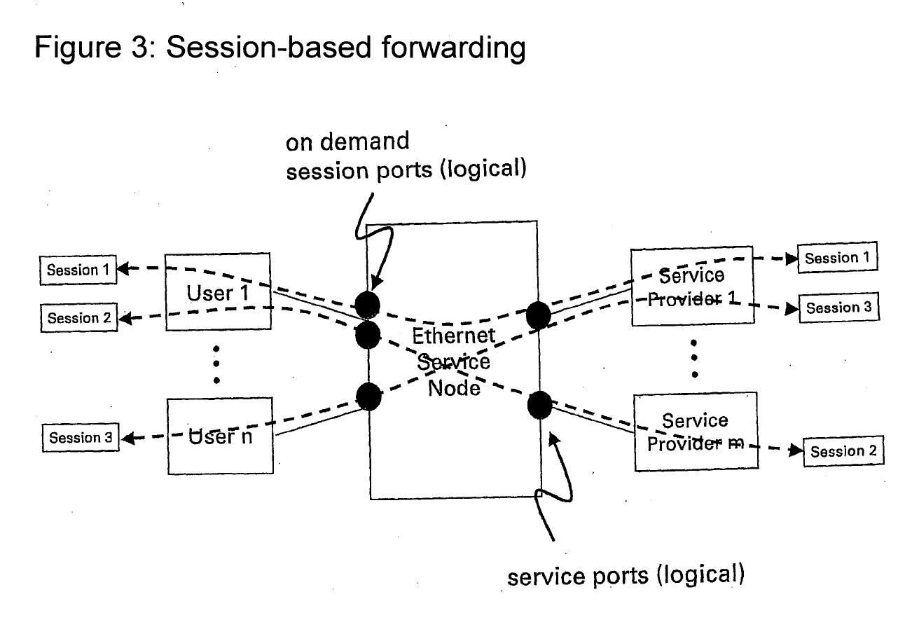

As shown in FIG. 3, for each user or service the ESN has a separate logical session interface to which all the packets of a user/service are assigned. A logical session interface can be defined, for example, by the combination of

1. physical Port and the user's MAC address (terminal)

2. port, MAC address and VLAN (also with a plurality of VLAN tags)

The individual logical session interfaces do not need to be configured manually, but are learned and dynamically generated automatically by the ESN at session setup. During session setup, the user normally has to log on, i.e. enter his user identification and authentication data such as a password. Only then is network access enabled by the ESN and the user connected to a service.

On the network side, for each service or class of service (e.g. Best Effort and Premium Service) the ESN has a separate logical service interface to which a session is permanently assigned. The assignment is defined either during session setup or later by direct service selection (typically via a service selection server).

A logical service interface on the network side can be defined e.g. by

1. a physical port and/or

2. a VLAN and/or

3. an MPLS path and/or

4. a special virtual network

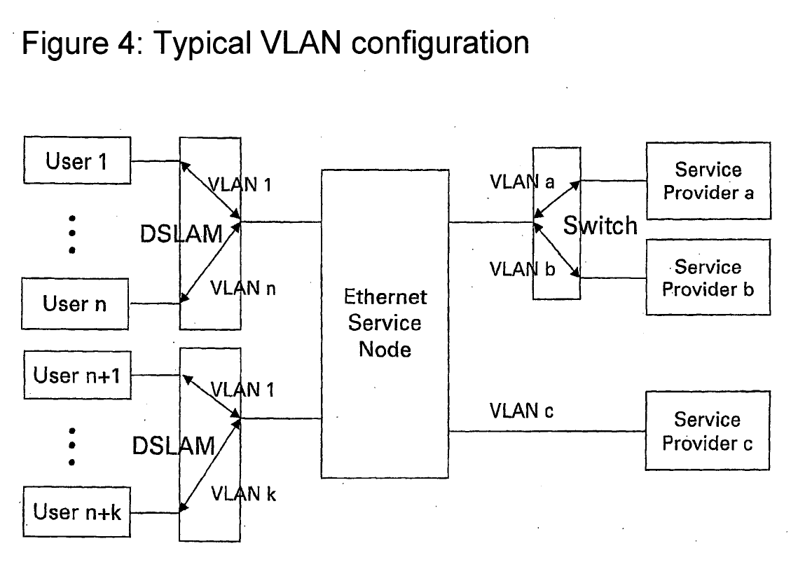

FIG. 4 shows by way of example the configuration of a simple network with ESN, two DSLAMs and three service providers. Here each user access of a DSLAM is assigned a separate VLAN which terminates in the ESN. The logical service ports are likewise connected to the service providers via VLANs. The ESN must now ensure that the data packets are correctly transported between the logical session and service ports.

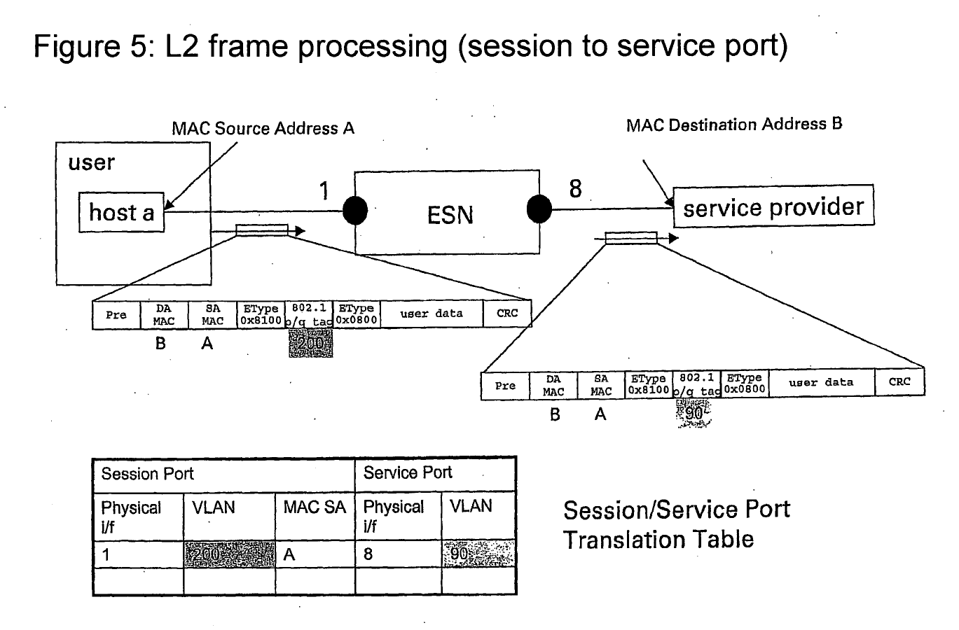

Within the ESN, data is transported on the basis of the session data, particular parts of the packet headers having to be analyzed for the assignment of the packets (e.g. MAC addresses, VLAN tags, priority bits, IP addresses, etc.). FIG. 5 shows an example of data transfer from the user to the network. Here, for example, the MAC source address and the VLAN header of received packets is analyzed in order to ascertain the assigned service interface (port, VLAN), resulting in the translation table shown in FIG. 5. An essential difference between the ESN and conventional Ethernet switches is that the packets are switched partly on the basis of the MAC source address.

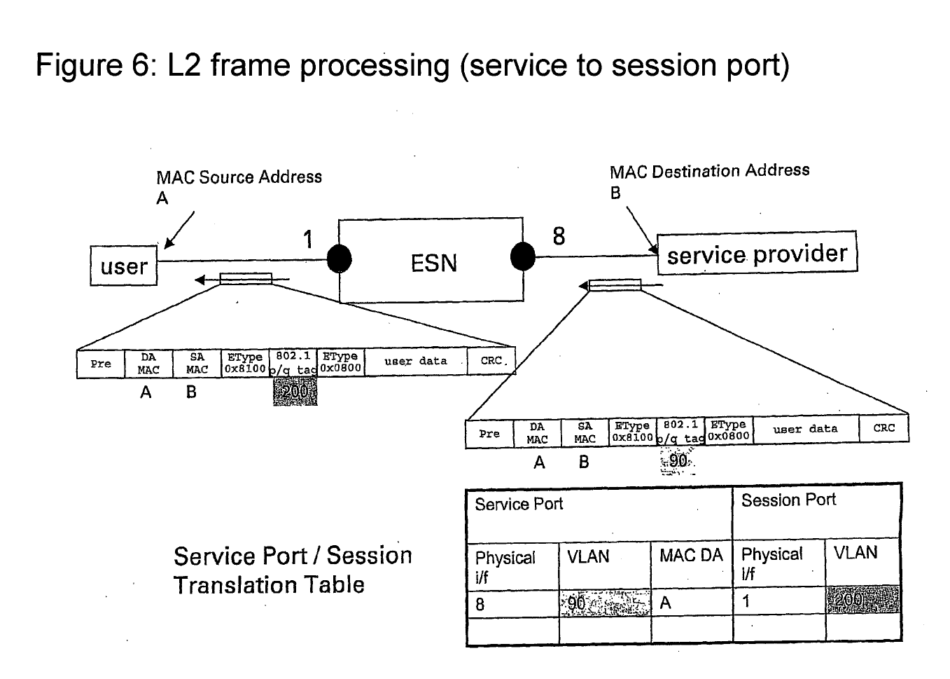

FIG. 6 shows the corresponding translation table on a service interface. Here the MAC destination address and the VLAN header are analyzed to assign the packets to a logical session port.

For time-dependent charging, the ESN must also be informed of the end of a session. A session can be terminated in various ways:
Explicit termination of the session by the client (e.g. PPPoE PADT)
Expiry/termination of a DHCP address lease
If no more data is received (idle timeout)
By explicit monitoring of the client, e.g. with periodic ARP request; session cleardown if no reply is received.
EAP reauthentication unsuccessful (802.1x)

After termination of a session, the ESN deactivates the logical session interface and the corresponding table entries are deleted.

In addition to the purely transport function, the ESN can provide yet more functions:
accessing a central user database for the purpose of authorizing the user and for calling up individual user data; in general, protocols such as RADIUS (RFC2865) or DIAMETER (RFC3588) are used for this purpose
individual limiting of the data rate of a session separately for incoming and outgoing packets (policing)
assigning the packets to a particular priority class
assigning individual filter rules
IP address assignment by DHCP, DHCP relay agent and insertion of the logical port data in DHCP (Option 82, RFC3046)
checking the IP source address of received packets (anti-spoofing)
collecting statistics data for each session, with corresponding RADIUS accounting (RFC2866)
PPPoE relay agent (detecting PPPoE sessions and forwarding PPPoE packets)
dynamic multicast session control using IGMP, e.g. for video distribution service
combination with external resource allocation servers for managing the bandwidth of individual classes of service (admission control and resource allocation)

For user access authorization there are likewise various possibilities:
Use of IEEE 802.1x, i.e. authorization by means of the EAP protocol (RFC2284). In contrast to the 802.1x standard, authorization is also possible with VLAN-based logical ports (802.1x permits only port- or VLAN-based authorization). For service selection, the well-known method of domain extension of the user ID can be used here (e.g. mueller@aol.com)
Use of a Web-based login, i.e. the user is first forwarded to a login server. After successful authorization, network access is enabled
Use of DHCP options for identifying and authorizing the user

Basically network access shall only be possible for authorized logical ports. All the other logical ports are blocked and only permit authorization.

### Advantages of the Inventive Solution

Simplified administration: subscriber access need only be created in the access node (DSLAM, edge switch). Session interfaces are generated by the ESN itself
Simplified network planning and dimensioning: service-based engineering of the aggregation network, with a significantly smaller number of logical connections
Simpler IP network planning with a small number of IP addresses by concentrating a large number of session ports onto a small number of service ports (e.g. VLANs). In the IP network a separate subnetwork is allocated for each VLAN.
Cost-saving by means of access control in the aggregation network, therefore a BAS no longer required
Quality of Service even in the aggregation network by monitoring user traffic as close as possible to the user access
Limiting of the number of MAC addresses per user access
Access to conventional BAS services by means of PPPoE relay still possible

### Differences compared to the Prior Art

An essential difference with respect to the conventional Ethernet switch is packet switching on the basis of the MAC source address, and translation of the VLAN ID
An essential difference with respect to the conventional BAS is session control and through-connection on layer 2 (MAC layer) instead of the IP layer (layer 3), and assignment of the sessions to service-specific logical interfaces (tunnels)
A new feature is the integration of access control into the Ethernet aggregation network.

### Exemplary Embodiment[s] of the Invention

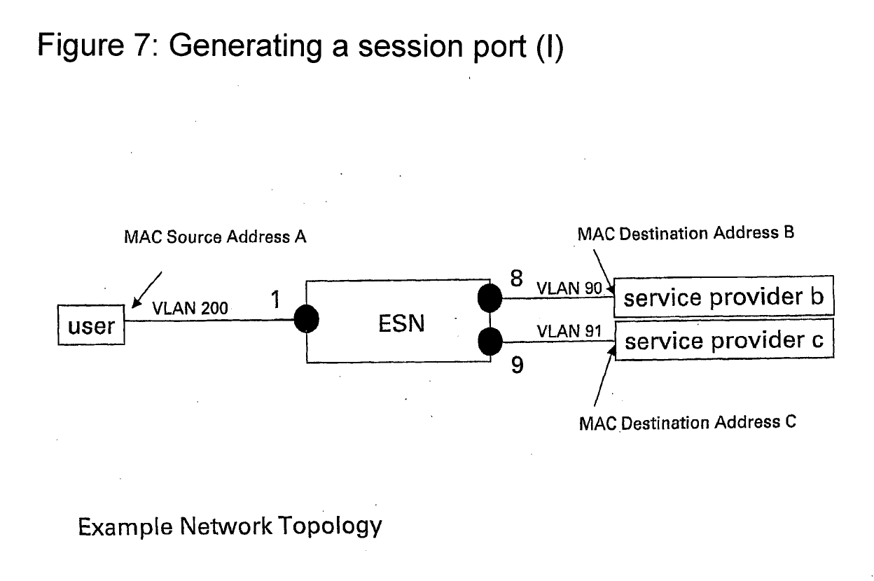

FIGS. 7, 8 and 9 show examples of autonomous learning of the data required for a session. FIG. 7 shows an example of a possible network configuration in which a user is connected to the ESN via VLAN 200. On the network side, two service providers are available, one at port 8/VLAN 90 and the other at port 9/VLAN 91.

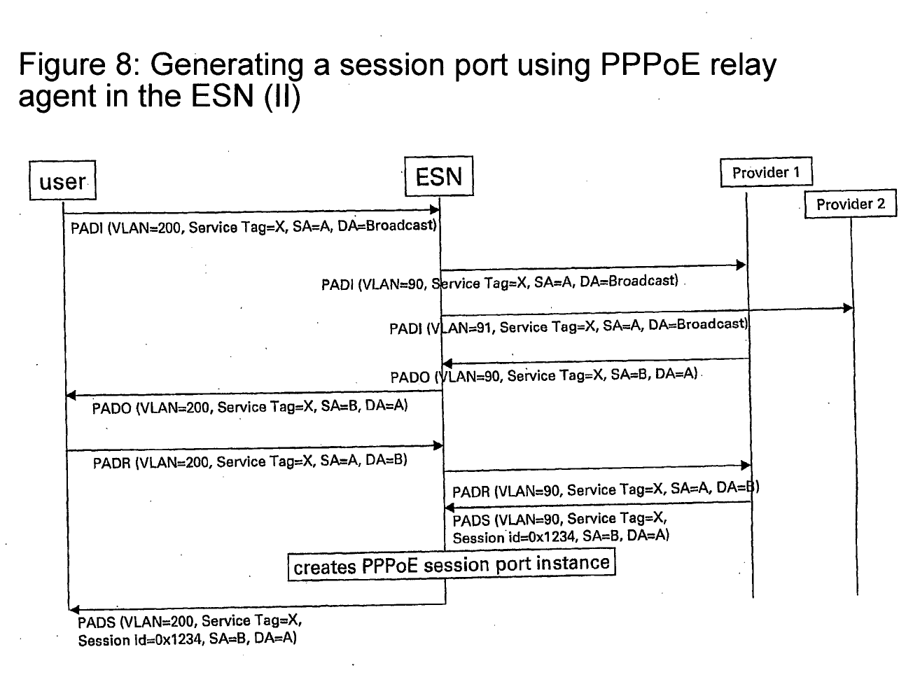

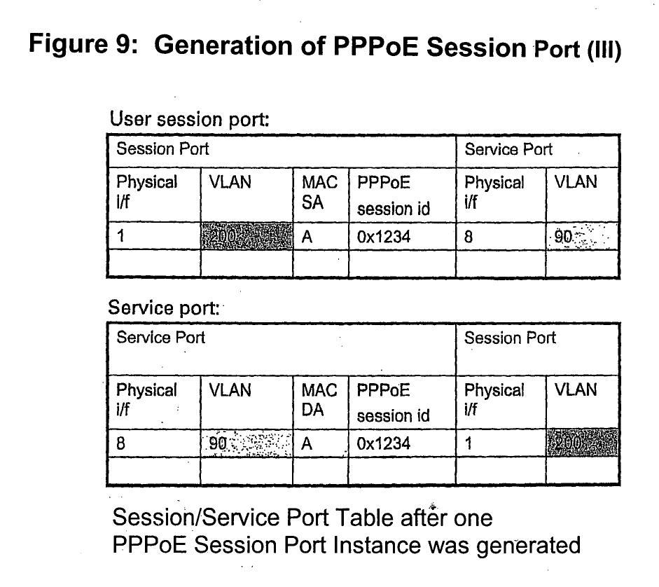

FIG. 8 shows the message flow for setting up a PPPoE session. The designations of the messages/packets correspond here to the terminology of the PPPoE definition in RFC2516. Session setup begins with a PPPoE discovery phase in which a PPPoE server is selected by means of the PADI and PADO packets. These packets are transmitted using a PPPoE relay agent in the ESN. The session is actually set up by the PADR packet (PPPOE active discovery request) and the subsequent PPPoE active discovery session confirmation (PADS) of the server. Here the session is also assigned a session ID which is included in all the following PPPoE packets. At this point the ESN has all the information required for generating a dynamic session, and for generating the translation tables for session and service ports shown in FIG. 9. With the activation of the table entries, direct communication between PPPoE client and server is enabled and the session is active.

### Abbreviations:

SSS: Service selection server
EAP: EAP (RFC2284) is a general authentication protocol which supports a plurality of authentication mechanisms.

1.-2. (canceled)

3. A method for session-based packet switching by a device, comprising
switching a received packet basis on a MAC source address or a MAC destination address; and
learning the assignment of the session to a logical service port during a session setup.

4. The method as claimed in claim 3, wherein the switching of the received packet is further based on a VLAN ID or source IP address.

5. A device for session-based packet switching in a network, comprising:
a provisioned service port to service provider;
a session port for a user of the network, the session port dynamically assigned during a setup of a session and based on a port and a MAC address of the user; and
a table entry effective to map between the session port and the service port for the session,
wherein during the session setup the dynamically assigned session port is mapped to a provisioned service port in the table entry.

6. The device as claimed in claim 5, wherein the session port is further based on a VLAN of the user.

7. The device as claimed in claim 5, wherein the session is terminated after: an idle timeout,
a expiry of a DHCP address lease,
explicitly by the user,
unsuccessful EAP reauthentication, or
no reply to an periodic ARP request.

8. The device as claimed in claim 5, wherein the table entry is deleted when the session is terminated.
